(19) United States
(12) Patent Application Publication
(10) Pub. No.: US 2003/0018482 A1
(43) Pub. Date: Jan. 23, 2003

(54) Www.i-want-2b.com

(76) Inventor: Barth Gordon McDonald, Kent, WA (US)

Correspondence Address: BARTH McDONALD, 25403-31st AVE SO., KENT, WA, 98032, US

(21) Appl. No.: 09/814,668

(22) Filed: Jul. 20, 2001

(51) Int. Cl. G06F 17/60

(52) U.S. Cl. 705/1

(57) ABSTRACT

The reason this sight is new is because this sight would focus on job descriptions for kids and adults around the world. Not only descriptions from businesses but from people in that actual job. This internet sight would be a new procedure to acquire information in determining future careers and college opportunities. The web sight would not focus on job openings, but instead it would focus on helping people discover a job, career, or profession that they would like or be good at. Students going into high school will use this sight to see what requirements and classes they should meet or take to obtain the job they want. Also any subjects (i.e. math, science, art, etc . . . ) that they should take more classes in to help them get their preferred job. Adults who never received a High School diploma can use this sight to see what colleges or programs they can attend or use to get a diploma. Also they can find out classes they are eligible for, High Schoolers may also use this sight to see scholarship opportunities, scholarship requirements, as well as funding and grant opportunities. Any adult ready for a career change can use this sight to see what other job or career they might be interested in and what requirements and or classes they will need to make the move. There will also be a section on job trends; what's hot, what's not; what type of jobs are stable or if they are volatile.

This sight would focus on job descriptions for kids and adults around the world. Not only descriptions from businesses but from people in that actual job. This internet sight would be a new procedure to acquire information in determining future careers and college opportunities.

The web sight would not focus on job openings, but instead it would focus on helping people discover a job, career, or profession that they would like or be good at. Students going into high school will use this sight to see what requirements and classes they should meet or take to obtain the job they want. Also any subjects (i.e. math, science, art, etc . . . ) that they should take more classes in to help them get their preferred job. Adults who never received a High School diploma can use this sight to see what colleges or programs they can attend or use to get a diploma. Also they can find out classes they are eligible for, High Schoolers may also use this sight to see scholarship opportunities, scholarship requirements, as well as funding and grant opportunities.

Any adult ready for a career change can use this sight to see what other job or career they might be interested in and what requirements and or classes they will need to make the move.

There will also be a section on job trends; what's hot, what's not; what type of jobs are stable or if they are volatile.

Part 1

### Learning Institutions

Any and all programs to increase one's knowledge and or abilities

1. Universities, Colleges, Jr. Colleges, Vocational Schools, Trade Schools, Apprentice Programs, company training Programs, and Home School/Training Programs

2. Information pertaining to the following: Scholarship Opportunities, Government Grants, Student Loans. Any Program that can help with receiving grant money or financing. How to apply for them and what is required to get them. What colleges spend on scholarships, what type of scholarships are available for academics and sports

3. What grade averages are required for which programs and how to get accepted for these programs. How the programs rate from one to ten

4. How much a degree will cost; trade; voc tech; etc . . .

5. Placement % in the career of choice

Part 2

### General Aptitude Test

1. Aptitude test to find out natural talents

2. Find out mental and physical strengths and weaknesses

3. A general guide and direction where their natural talents will do best at

4. What occupations relate to your interests and vice versa

5. Link to a job description

Part 3

### Job Descriptions

1. An all out list of all jobs and a full description of each, and what it takes to aquire that job

2. Levels of salaries for all jobs

3. Letters from people who are already in that field telling what the job is like, what they like and dislike, what they do on a daily basis, benefits they get, and stress level

4. Bulletin boards for people to ask questions about careers

Part 4

### Pick of the Litter

1. teachers and coaches will have a place to link students with extremely high skills in one area of study but not in others to secondary colleges and/or business programs that their skills will relate to

2. thus giving opportunity to kids who excel in one subject or sport but are weak in others, to create opportunities in college and business where as normally a college or business would overlook them for just the kids with high GPA's

3. thus enabling students, colleges, and businesses to interact with each other to create opportunities that wouldn't normally be there

4. students will be able to post their career of choice making colleges more interested in recruting kids for jobs with a lack of work force. An example would be, right now there is a shortage of teachers. If a student wants to become a teacher, colleges would want to recruit him to fill the empty jobs.

I claim:

1. A website for everybody to discover information about colleges and learning institutions, college requirements, scholarships, financial support for schooling, cost of colleges, grants, funding, aptitude skills, jobs, job opportunities, job conditions, job salaries, job training, job requirements, career choices, and career changes.
